(19) United States
(12) Patent Application Publication
(10) Pub. No.: US 2015/0109759 A1
(43) Pub. Date: Apr. 23, 2015

(54) Optical Source Device

(71) Applicant: Mitsubishi Electric Engineering Company, Limited, Tokyo (JP)

(72) Inventors: Tetsuo Sugano, Tokyo (JP); Hiromi Takao, Tokyo (JP)

(73) Assignee: Mitsubishi Electric Engineering Company, Limited, Tokyo (JP)

(21) Appl. No.: 14/268,330

(22) Filed: May 2, 2014

(30) Foreign Application Priority Data
Oct. 18, 2013 (JP) 2013-217264

(51) Int. Cl. F21K 99/00

(52) U.S. Cl. CPC F21K 9/56
USPC 362/84

(57) ABSTRACT

The optical source device for a medical use or an industrial use can emit light of only an optical component of a required wavelength band without using xenon or filter and being harmful to not only an object itself such as an operated part but also an operator or observer and with a high efficiency and a high function. The device comprises a plurality of luminescent portions which each have a different luminescent wavelength band; wavelength restricting portions which each restrict each luminescent wavelength band of the luminescent portions; a mixing portion which mixes the outputs of the wavelength restricting portions; and a controlling portion which controls each luminescent output of the luminescent portions to emit light of only a necessary wavelength band.

### BACKGROUND OF THE INVENTION

1. Field of the Invention

The present invention relates to an optical source device for a medical use or an industrial use, and in particular to an optical source device that emits light of only an optical component of a necessary wavelength band.

2. Description of the Related Art

In a conventional optical source used for an endoscope system for observing tissues within a body cavity, for example a xenon optical source is well known in the art as having a high intensity and a very wide band characteristic in the luminescent wavelength. For this reason, xenon has been applicable not only for a visible optical source but also a fluorescent image observing optical source, and so is widely used for dealing with necessary wavelengths in combination with optical filters.

Recently, LED has been developed toward a higher intensity and so widely used for a consumer use as well as an industrial application such as from an electric torch to a residential illumination or traffic light. In addition, it is also being used in the field of an optical source such as an experimental high intensity optical source. Also, there exists an optical source utilizing a semiconductor laser for a special application taking advantage of a laser light enabling luminescence (light emission) of a specified wavelength.

On the other hand, what can be substituted for a xenon optical source as a visible optical source which emits a stable and safe incandescent light is now under consideration.

As the prior art, is cited an external optical source device enabling irradiation of excitation light corresponding to various kinds of phosphor matters and a sure removal of a heat ray from illumination light (see, e.g. Japanese Patent Application Laid-open No. 2009-140827: Patent Document 1). This Patent Document 1 includes a xenon lamp in the inside, in which the illumination light from the xenon lamp is irradiated to an affected part of body observed by a medical use-microscope through an irradiation port, and an optical means is fixed for cutting optical fluxes on a longer wavelength side than a threshold value in an internal optical path of the illumination light from the optical source to the irradiation port with the threshold value being made between 805 nm to 815 nm.

Also, another prior art device reduces the power consumption in an optical source portion of an electric endoscope device and increases the luminescence (light emission) quantity without enlarging the luminescence area (see, e.g. Japanese Patent Application Laid-open No. 2007-68699: Patent Document 2). This Patent Document 2 uses three LEDs for RGB with respect to a visible light range different from the luminescence spectrum, enabling the enhancement of light quantity without enlarging the luminescence area by combining the radiation lights from the LEDs into a single incandescent light via a dichroic prism or the like.

However, the above prior art devices have the following problems:

The xenon optical source of Patent Document 1 employs a filter for countermeasures against the heat ray, which is not, however, complete countermeasures because it includes the light of 700-800 nm that is a part of near-infrared. Namely, an optical source device when composed of xenon would have a high intensity and wide band, and so would be advantageous in respect of observation, operation, camera image or the like.

On the other hand, in respect of an object, operator or observer it contains a high proportion of an unnecessary wavelength band component such as a near-infrared light that is an unnecessary heat ray component as well as an ultraviolet component adversely affecting retina or skin. This complicates a long-term use and requires special countermeasures such as glasses or against a heat ray in use, failing to take full advantage thereof regardless of its high intensity.

In case of an optical source used for observing fluorescent images in the medical use or industrial use, there exists the one having a structure which passes only a necessary wavelength through an optical filter by taking advantage of a wide band proper of xenon. However, this requires filtering from a high intensity/wide band to a narrow band, thereby causing a heat generation in the filtering portion, an unstable spectroscopic characteristic and a low luminescence efficiency.

In respect of lifetime, xenon is decreased by half in the intensity in approximately 500 Hrs, that is a short lifetime in comparison with a semiconductor optical source, so that its lamp is required to be exchanged frequently to maintain a high intensity at all times. Also, xenon is disadvantageous in maintenance because it is difficult to automatically detect the luminescence state, which requires a precaution exchange in advance of lamp blowout due to its lifetime.

On the other hand, Patent Document 2 does not restrict the luminescence band characteristic of an LED itself, disabling only an optical component of a required wavelength band to be taken out.

### SUMMARY OF THE INVENTION

The present invention has been made to solve the problems described above, and has accordingly an object to provide an optical source device which can emit light of only an optical component of a required wavelength band without using xenon or filter.

An optical source device according to the present invention comprises a plurality of luminescent portions which each have a different luminescent wavelength band; wavelength restricting portions which each restrict each luminescent wavelength band of the luminescent portions; a mixing portion which mixes outputs of the wavelength restricting portions; and a controlling portion which controls each luminescent output of the luminescent portions to emit light of only a necessary wavelength band.

According to the present invention, an optical source device is provided which can emit light of only an optical component of a necessary wavelength band without using xenon or filter by controlling the luminescent outputs of a plurality of luminescent portions and restricting the band of the other luminescent wavelengths to suppress an optical component of an unnecessary wavelength harmful to human bodies as well as adverse effects on an object, operator, or observers.

### BRIEF DESCRIPTION OF THE DRAWINGS

In the accompanying drawings:

FIG. 1 is a block diagram showing a first embodiment of an optical source device according to the present invention;

FIG. 2 is a whole spectroscopic characteristic graph of an optical source in the first embodiment of the optical source device according to the present invention;

FIG. 3 is a block diagram showing a specific example of particularly an optical signal mixing portion in the optical source device shown in FIG. 1;

FIG. 4 is a spectroscopic characteristic graph of an LED luminescent portion in the first embodiment of the optical source device according to the present invention;

FIG. 5 is a block diagram showing a second embodiment of the optical source device according to the present invention;

FIG. 6 is a whole spectroscopic characteristic graph of the optical source in the second embodiment of the optical source device according to the present invention;

FIG. 7 is a luminescent wavelength control characteristic graph with temperature of a laser luminescent portion in the second embodiment of the optical source device according to the present invention;

FIG. 8 is a luminescent strength characteristic graph with current of the laser luminescent portion in the second embodiment of the optical source device according to the present invention; and

FIG. 9 is a block diagram showing a specific example of particularly each laser luminescent portion in the second embodiment of the optical source device according to the present invention.

### DETAILED DESCRIPTION OF THE PREFERRED EMBODIMENT

In the following, preferred embodiments of an optical source device according to the present invention will be described referring to the drawings.

### First Embodiment

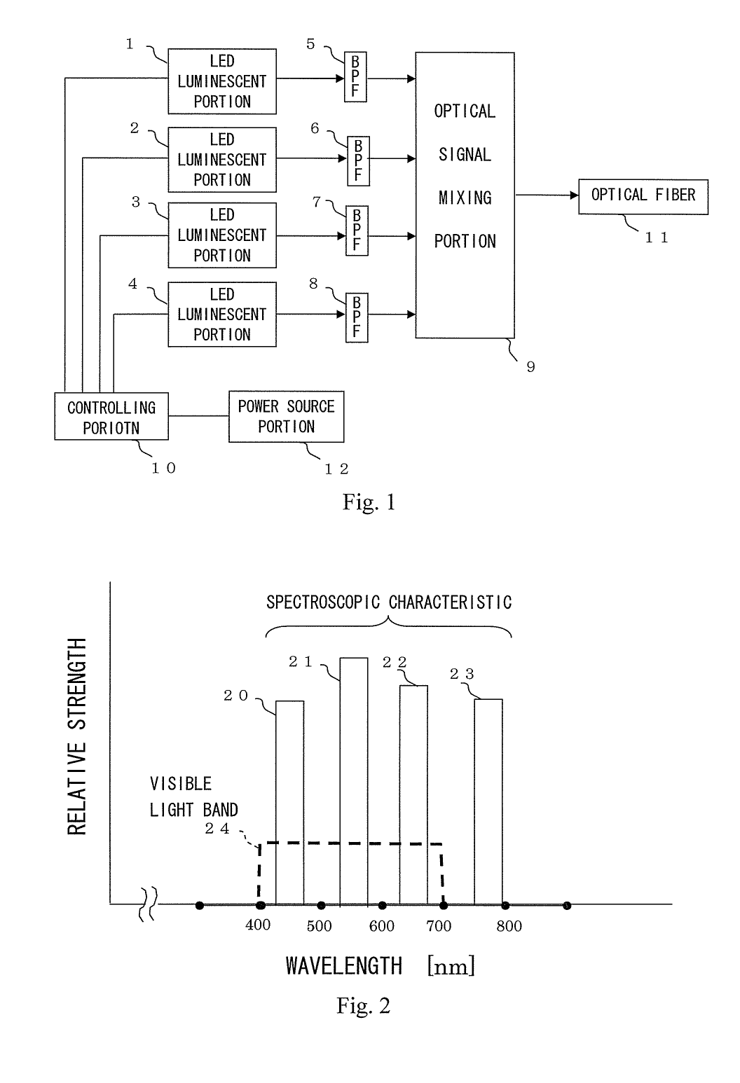

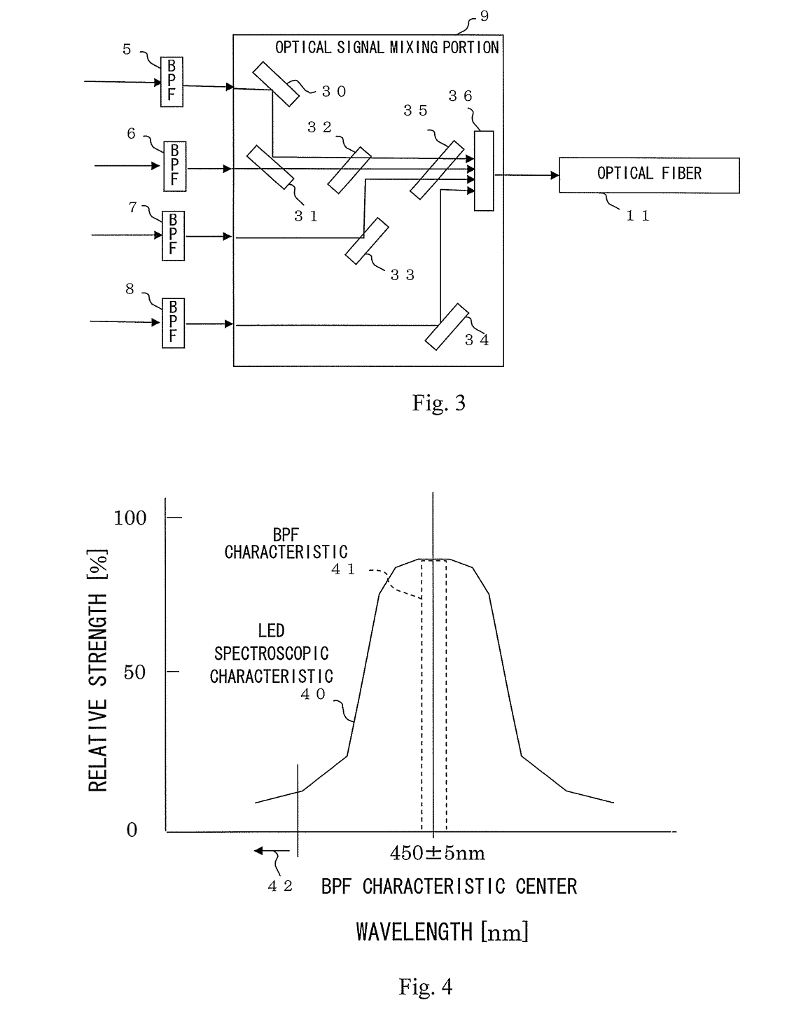

FIGS. 1-4 show a first embodiment of an optical source device according to the present invention, in which FIG. 1 shows a whole arrangement, FIG. 2 shows a whole spectroscopic characteristic example of the optical source, FIG. 3 shows an arrangement of an optical signal mixing portion, and FIG. 4 shows an LED luminescent characteristic.

Referring to FIG. 1, it shows an arrangement of a device using LEDs as luminescent elements for an optical source. The outputs of a plurality of LED luminescent portions 1-4 whose luminescent outputs are controlled by a controlling portion 10 are transmitted through BPFs (Band Pass Filters) 5-8 which optically restrict the output wavelengths to an optical signal mixing portion 9 which mixes those outputs and then to an optical fiber 11 for taking the mixed light to the outside. The power source of each circuit is supplied by a power source portion 12.

The whole spectroscopic characteristic example of the optical source in FIG. 2 will now be described. The outputs of the LED luminescent portions 1-4 have respectively spectroscopic characteristics 20-23. Namely, the LED luminescent portions 1-3 respectively correspond to the spectroscopic characteristics 20-22 ranging between 400-700 nm of a visible light band 24. The LED luminescent portion 4 emits light in the vicinity of 780 nm of the spectroscopic characteristic 23. This arrangement provides one luminescent portion for emitting light of one wavelength band.

A specific example of the optical signal mixing portion 9 shown in FIG. 1 will now be described referring to FIG. 3. An optical mirror 30 reflects the output light of the LED luminescent portion 1. An optical mirror 31 passes therethrough the output light of the LED luminescent portion 2. An optical mirror 32 passes therethrough the output lights of the LED luminescent portions 1 and 2. Optical mirrors 33 and 34 respectively reflect output lights of the LED luminescent portions 3 and 4. An optical mirror 35 passes therethrough the output lights of the LED luminescent portions 1-3. Then, the output lights of the optical mirrors 34 and 35 are collected at a collecting lens 36 and then transmitted to the optical fiber 11.

Spectroscopic characteristic examples of the LED luminescent portions 1-4 shown in FIG. 1 will now be described referring to FIG. 4. An LED spectroscopic characteristic 40 shows a luminescent wavelength characteristic of a single LED. By inserting an optical filter such as having a BPF characteristic 41 into the output side of the luminescent portion with respect to the LED spectroscopic characteristic 40, the band of luminescent wavelength is restricted so as to cut an ultraviolet area 42. It is to be noted that FIG. 4 typically shows an individual characteristic among the spectroscopic characteristics 20-23 in FIG. 2.

An operation of the first embodiment will now be described referring to FIGS. 1-4.

When the power source is turned on, the power is supplied to necessary portions such as the controlling portion 10 from the power source portion 12, presenting an operable state as a power source. The controlling portion 10 performs a driving control concurrently with the power source supply to activate or make an LED of the LED luminescent portion 1 luminescent.

The LED luminescent portion 1 emits light of a wavelength of 450±50 nm (half value width) under a rated power source supply. At this time, the luminescence of 450±50 nm includes a high proportion of an ultraviolet range, that is a wavelength shorter than a blue color, with respect to a wavelength bandwidth. For the purpose of taking out a necessary blue color component as a visible light source, a BPF 5 having the BPF characteristic 41 (450±2 nm) shown in FIG. 4 is optically inserted, thereby performing a wavelength band restriction to the LED luminescent portion 1.

Thus, with the LED luminescent portion 1 and the BPF 5, the luminescence where the wavelength and the band are restricted to 450±2 nm is made. This wavelength is of a blue color which can form a visible optical source in combination with a red color and a green color in the latter stage.

In the same manner as the above, the controlling portion 10 supplies a power source to each portion to activate the LEDs of the LED luminescent portions 2-4 for the luminescence. Each of the LED luminescent portions has a half value width of approximately ±50 nm, which should be restricted in band by an optical filter in the same as the LED luminescent portion 1.

In FIG. 1, the output of the LED luminescent portion 2 has the BPF 6, the output of the LED luminescent portion 3 has the BPF 7, and the output of the LED luminescent portion 4 has the BPF 8 respectively optically inserted thereafter, in which the band of each luminescent wavelength is restricted as follows:
LED luminescent portion 2: Wavelength of 550±2 nm by BPF 6 with the rated power source supply;
LED luminescent portion 3: Wavelength of 650±2 nm by BPF 7 with the rated power source supply;
LED luminescent portion 4: Wavelength of 780±2 nm by BPF 8 with the rated power source supply.

As shown by a schematic block diagram of the optical signal mixing portion 9 in FIG. 3, the output lights of the LED luminescent portions are mixed in the form of four wavelengths in combination with specific mirrors where a certain band wavelength is passed and a different certain band wavelength is reflected, collected at the optical fiber 11 through the collecting lens 36 and provided as an output from the optical source device proper for the use by external devices requiring optical sources. The optical fiber 11 is connected to the external devices requiring optical source light through a dedicated attachment (not shown) so as to use the light as effective as possible.

While the arrangement as described above has four luminescent wavelengths for an optical source, at a normal operation for the visible optical source the controlling portion 10 performs a control such that only the LED luminescent portions 1-3 are activated for the luminescence while the LED luminescent portion 4 is deactivated for the non-luminescence.

At the time of fluorescent observation with an indocyanine green-fluorescent angiogram agent, a user operates to change the observation mode, whereby the controlling portion 10 controls the LED luminescent portion 4 to emit light of the wavelength of 780±2 nm through the BPF 8.

As illustrated referring to FIGS. 1-4, the optical source device according to the first embodiment has an arrangement for emitting light by properly selecting necessary luminescent portions according to the operation purposes. With such an arrangement, it becomes possible to realize an optical source with a high precision and a high efficiency which can selectively emit light of a controlled or managed wavelength band without generating an unnecessary light such as in a ultraviolet range harmful to eyes or skins or near-infrared range affecting as heat ray. While only one luminescent element for each wavelength may be used, it is needless to say that one LED luminescent portion may retain a plurality of luminescent elements. The controlling portion 10 activates the luminescent elements usually used in a normal condition for the luminescence, and controls to exchange them to reserved luminescent elements when they fail to emit light for some reason.

At this time, by the provision of a detection circuit for each LED luminescent element, it can be decided that the luminescence is more likely to have stopped when the detection circuit detects a current equal to or lower than a certain value. Then, the controlling portion 10 can inform, in some way, users of the luminescent element having gone home by a self-diagnosis based on that decision and concurrently continue the luminescence as an optical source by changing from the failed luminescent element to the reserved luminescent element.

It is to be noted that such a self-diagnosis function can be achieved by reading a secular change of current detected by the detection current. Specifically, the controlling portion 10 can detect preliminarily an abnormal condition that the luminescence stop approaches when the current gradually decreases during the use of the luminescent element and then the current detected by the detection circuit has fallen below a certain value.

It is to be noted that the luminescent wavelength of the LED luminescent portion may be any of the wavelengths as required. Namely, the luminescent wavelength of the LED luminescent portion 1 may be not 450 nm but may be either 440 nm or 460 nm if an arrangement for a blue color as a visible light is selected. Also, the wavelength bandwidth may be decided depending on a range as required, so that it may not be ±2 nm as described above but may be in the order of e.g. ±10 nm in the event of a range without adverse effect on a human body.

Also, the luminescent portions which emit light of an excitation light wavelength of an angiogram agent may similarly have any of the wavelength bands as required. Namely, the LED luminescent portion 4 may not have the wavelength band of 780±2 nm but may have the wavelength band of e.g. 800 nm±5 nm in the vicinity of the peak of excitation efficiency. Besides the indocyanine green, an excitation light wavelength of another fluorescent angiogram agent such as a fluorescein in the vicinity of 490 nm or 5ALA in the vicinity of 400 nm may be used without any problem.

Furthermore, a wavelength forming a visible light and an excitation light wavelength of the fluorescent angiogram agent may be shared. For example, by making the blue color of the LED luminescent portion 1 assume 490 nm in the vicinity of the excitation light of the fluorescein fluorescent angiogram agent and activating the LED luminescent portion 1 together with the LED luminescent portions 2 and 3 when used for a visible light illumination, a visible incandescent light can be emitted. On the other hand, at the time of observation with the fluorescent angiogram agent, only the LED luminescent portion 1 is activated for the luminescence, thereby enabling the luminescent portions efficiently depending on the purpose to be utilized. Any of these operations can be achieved by the controlling portion 10 which performing the luminescence controls.

Furthermore, the luminescent elements used are not limited to LEDs or semiconductor lasers, where if they can be controlled or limited in the wavelength and band, any other laser element or luminescent element may be used.

### Second Embodiment

While the first embodiment aforementioned has been described upon using LEDs as luminescent elements of optical source, this second embodiment will be described upon using semiconductor lasers as luminescent elements of optical source.

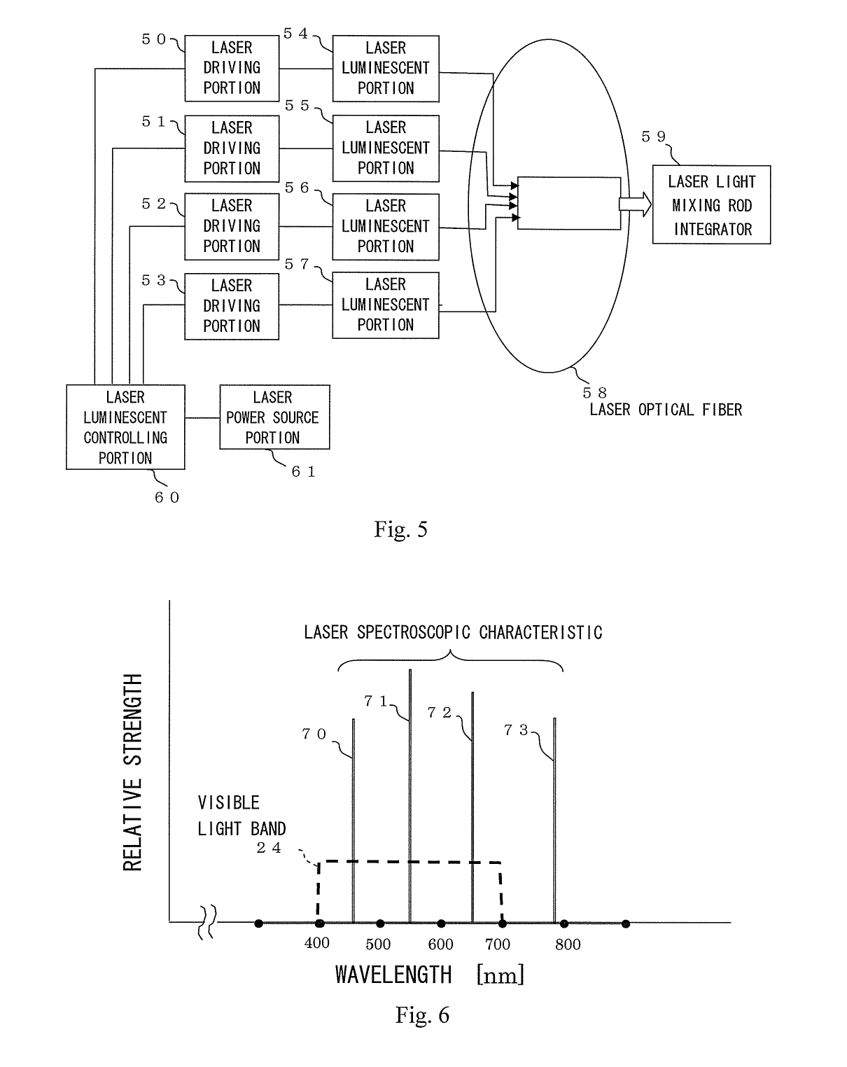

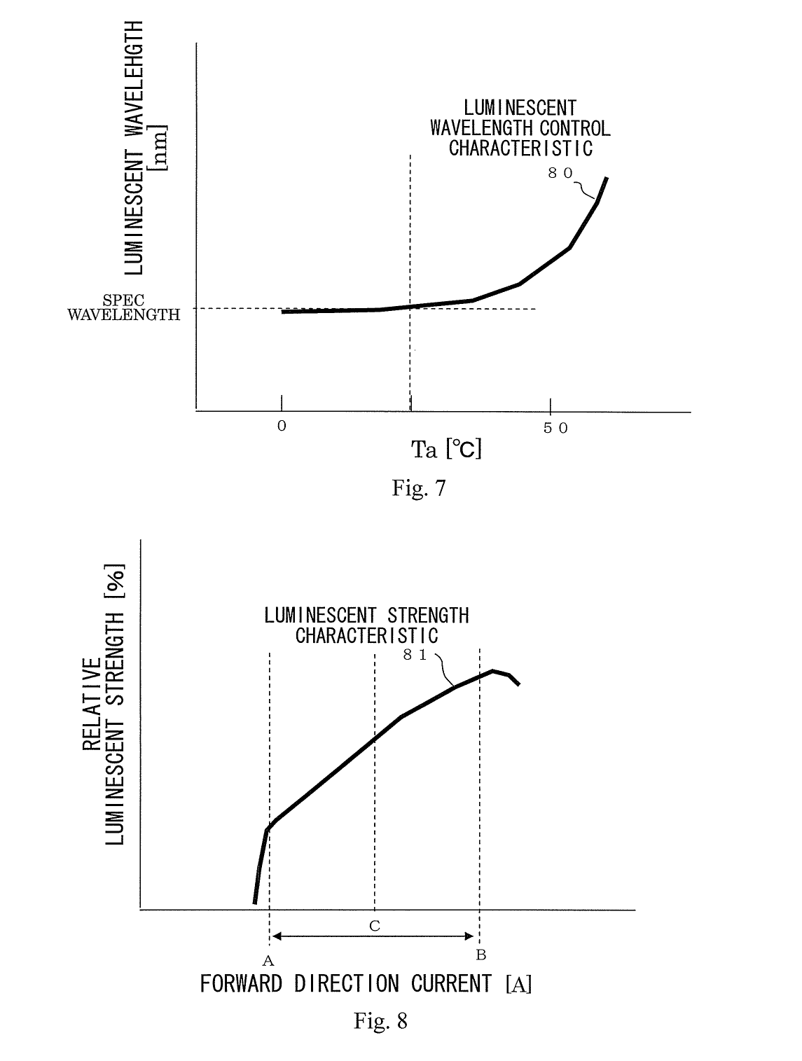

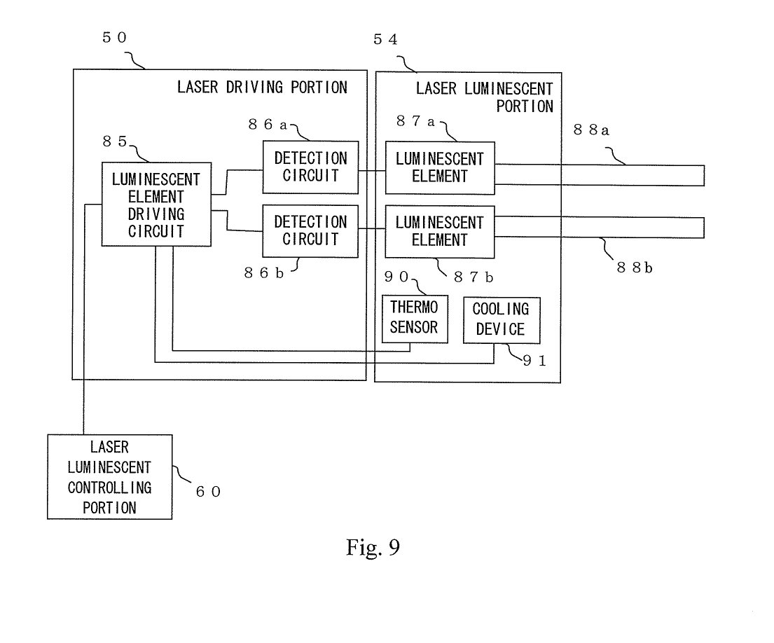

FIGS. 5-9 show the second embodiment of the optical source device according to the present invention, in which FIG. 5 shows a whole arrangement example, FIG. 6 shows a whole spectroscopic characteristic example of the optical source, FIG. 7 shows a luminescent wavelength control characteristic example with temperature, FIG. 8 shows a luminescent strength characteristic example with current according to the present invention, and FIG. 9 shows an arrangement example of a laser luminescent portion per wavelength.

Referring to FIG. 5, is shown a device arrangement using semiconductor lasers as luminescent elements of optical source. Specifically, the optical source device in this second embodiment is composed of a laser luminescent controlling portion 60, a plurality of laser driving portions 50-53, a plurality of laser luminescent portions 54-57, a plurality of laser optical fibers 58, a laser light mixing rod integrator 59 and a laser power source portion 61.

The whole spectroscopic characteristic example of the optical source in FIG. 6 will be described. The outputs of the laser luminescent portions 54-57 have respectively laser spectroscopic characteristics 70-73. The laser spectroscopic characteristics which the laser luminescent portions 54-56 have respectively correspond to the spectroscopic characteristics 70-72 that are in the range of 400-700 nm of the visible light band 24, enabling a normal visible optical source to be operated.

On the other hand, the laser luminescent portion 57 has for example a wavelength of 780 nm of the spectroscopic characteristic 73, and emits light of a wavelength according to a special application. Thus, the laser luminescent portions 54-57 are arranged to emit light of a single wavelength band per a single luminescent portion.

Now, a luminescent wavelength control characteristic with temperature will be described referring to FIG. 7. FIG. 7 shows a wavelength characteristic example of a semiconductor laser, in which a luminescent wavelength control characteristic 80 reveals a luminescent wavelength extending after the temperature exceeds Ta. Therefore, this second embodiment utilizes the luminescent wavelength control characteristic 80 depending on temperature to control and restrict luminescent wavelengths for an optical source.

Next, referring to FIG. 8, a luminescent strength characteristic example with current will be described. FIG. 8 shows a luminescent characteristic example of a semiconductor laser, in which the luminescent strength characteristic example 81 indicates a relative luminescent strength in relation to a forward direction current. Therefore, this second embodiment takes advantage of this luminescent strength characteristic example 81 depending on a forward direction current to detect a luminescent state of an optical source from the detection result of the current.

Next, referring to FIG. 9, a specific arrangement example per each laser luminescent portion will be described. FIG. 9 shows, as one example, an internal arrangement of the laser driving portion 50 and the laser luminescent portion 54. The laser driving portion 50 is mainly composed of a luminescent element driving circuit 85 and two detection circuits 86a, 86b. The laser luminescent portion 54 is mainly composed of two luminescent elements 87a, 87b as well as a thermo sensor 90 and a cooling device 91.

The luminescent elements 87a, 87b output optical source lights respectively through the optical fibers 88a, 88b. In a normal operation mode, the laser luminescent controlling portion 60 controls to activate a semiconductor laser in the luminescent element 87a for the luminescence.

Hereafter, an operation of the second embodiment will be described referring to FIGS. 5-9.

In the power-on state, a power source is supplied to necessary portions such as the laser luminescent controlling portion 60 from the laser power source portion 61. The laser luminescent controlling portion 60 performs a power source supply and a driving control to the laser driving portion 50 in order to activate a semiconductor laser of the laser luminescent portion 54 for the luminescence.

The laser luminescent portion 54 emits light of a wavelength of 450±2 nm by a rated power source supply and a thermal control. The laser luminescent controlling portion 60 performs the driving control so that a current value detected by the detection circuit 86a may assume a current value at a central C point between currents A-B shown by the luminescent strength characteristic example 81 in FIG. 8 in order to maintain the laser luminescence of 450±2 nm.

The luminescence of a semiconductor laser is associated with an optical resonance and so requires a current more than a certain threshold value. The A point in FIG. 8 is the threshold current for the element, so that the laser luminescent controlling portion 60 controls to assume a current value of the central C point that is a current more than A for maintaining the luminescence, as above described.

Then, the laser luminescent controlling portion 60 also takes advantage of the luminescent wavelength control characteristic example 80 depending on temperature in FIG. 7 to perform a thermal control for maintaining the luminescence of 450±2 nm. Specifically, the laser luminescent controlling portion 60 controls the cooling device 91 based on the temperature sensed by the thermo sensor 90 shown in FIG. 9, thereby performing the thermal control for the luminescent elements 87a, 87b to assume 20-25° C.

The luminescent wavelength of a semiconductor laser depends on a physical property forming the element and its structure, while on the other hand a temperature during the luminescence. Therefore, a thermal control is required for maintaining the luminescent wavelengths.

By such a driving control and a thermal control from the laser luminescent controlling portion 60, the laser luminescence of 450±2 nm is maintained. This wavelength provides a blue color and forms a visible optical source in combination with a red color and a green color in the latter stage.

In order to activate the semiconductor lasers of the laser luminescent portions 55-57 for the luminescence in the same manner as above, the laser luminescent controlling portion 60 performs the following power source supply and driving control to the laser driving portions 51-53:
Laser luminescent portion 55: Wavelength of 550±2 nm by rated power source supply and thermal control;
Laser luminescent portion 56: Wavelength of 650±2 nm by rated power source supply and thermal control;
Laser luminescent portion 57: Wavelength of 780±2 nm by rated power source supply and thermal control.

In order to maintain the respective laser luminescences, the laser luminescent controlling portion 60 performs the driving control so that the current value detected by the detection circuit 86a may assume a current value of the central C point between the currents A-B shown by the luminescent strength characteristic example 81 in FIG. 8.

The luminescence of a semiconductor laser is associated with an optical resonance and so requires a current more than a certain threshold value. The A point in FIG. 8 is the threshold current of this element, so that the laser luminescent controlling portion 60 controls to assume the current value of the central C point that is more than the A point for maintaining the luminescence as described above.

The laser luminescent controlling portion 60 also controls the cooling device 91 based on the temperature sensed by the thermo sensor 90 shown in FIG. 9 as described above, thereby performing the thermal control to assume 20-25° C. for the luminescent elements 87a, 87b. Resultantly, as with the wavelength of 450±2 nm, the laser luminescences of the wavelengths of 550±2 nm, 650±2 nm and 780±2 nm are also maintained.

It is to be noted that the three wavelengths of a green color of 550±2 nm, a red color of 650±2 nm, and a blue color of 450±2 nm as described form a visible optical source.

The lights of the four wavelengths, i.e. the three wavelengths for the visible optical source and the wavelength of 780 nm±2 nm for the special application are collected by laser light mixing rod integrator 59 through the laser optical fiber 58. By being diffused by the rod integrator 59, the laser light is uniformized without coherent property and becomes an optical output having a spectroscopic characteristic shown in FIG. 6 after having been converted into a character similar to a natural light.

The lights of the laser luminescent portions 54-57 are outputted, as described in the foregoing, from the optical source device proper for the external equipment requiring an optical source, through the laser light mixing rod integrator 59 from the laser optical fiber 58. The optical fibers 88a, 88b are connected to the external equipment requiring this optical source light through a dedicated attachment (not shown) so as to use the light as efficient as possible.

While the above has been described as an arrangement of four luminescent wavelengths as an optical source, at the time of usual operations as a visible optical source the laser luminescent controlling portion 60 controls to activate only the laser luminescent portions 54-56 for the luminescence and deactivate the laser luminescent portion 57 for the special application.

As illustrated referring to FIGS. 5-9, the optical source device according to the second embodiment has an arrangement to properly and selectively activate the luminescent portions required depending on an application purpose. With such an arrangement, it is possible to realize an optical source with a high precision and a high efficiency without emitting unnecessary light such as in the ultraviolet range harmful to eyes or skins and the near-infrared range affecting as heat ray and capable of selectively emitting the light of the wavelength band as managed or controlled.

It is needless to say that while only one luminescent element may be used for each wavelength, a plurality of luminescent elements may be retained in the laser luminescent portion 54. While activating the luminescent element 87a in a normal condition, the laser luminescent controlling portion 60 controls to change it to the reserved luminescent element 87b when the luminescence has failed for some reason.

At this time, with a detection circuit being provided for each laser luminescent element, it is possible to decide that the luminescence is more likely to have stopped when the current detected by the detection circuit 86a becomes lower than the A point in the threshold current characteristic example. Therefore, the laser luminescent controlling portion 60 can inform, in some way, users of the fact that the luminescent element has gone home by a self diagnosis based on that decision and concurrently continues the luminescence as an optical source by changing to the reserved luminescent element 87b from the luminescent element 87a.

It is to be noted that the self diagnostic function can be achieved by reading a secular change of current detected by the detection circuit. Specifically, the controlling portion 10 can preliminarily detect an abnormal condition that the luminescent stop approaches when during the use of the luminescent element, the current gradually decreases and the current detected by the detection circuit falls into e.g. a value slightly higher than the A point.

It is to be noted that the luminescent wavelength of the luminescent portion may have any wavelength as required. Namely, the wavelength may not be 450 nm but may be 440 nm or 460 nm if the one which provides a blue color as a visible light is selected for the laser luminescent portion 54. Also, the wavelength bandwidth may be determined depending on a range as required, in which it may not be ±2 nm as above but may be the one in the order of e.g. ±10 nm unless the range gives an adverse effect on a human body.

Also, the luminescent portion which generates an excitation light wavelength of an angiogram agent may similarly have any of the wavelength bands as required. Namely, the laser luminescent portion 57 may not use 780±2 nm but may use e.g. 800 nm±5 nm in the vicinity of an excitation efficiency peak. Besides the indocyanine green, an excitation light wavelength of another fluorescent angiogram agent, such as a fluorescein in the vicinity of 490 nm or 5ALA in the vicinity of 400 nm may be used without any problem.

Further, the wavelength forming a visible light and an excitation light wavelength of the fluorescent angiogram agent may be shared. For example, by making the blue color of the laser luminescent portion 54 assume 490 nm in the vicinity of the fluorescein fluorescent angiogram agent and activating the laser luminescent portion 55 and the laser luminescent portion 56 as well as the laser luminescent portion 54 for the luminescence when used for a visible light illumination, a visible incandescent light can be emitted. On the other hand, at the time of observation with fluorescent angiogram agent, only the laser luminescent portion 54 is activated for the luminescence, thereby enabling the luminescent portions effectively depending on the purpose to be utilized. Any of these operations can be achieved by the laser luminescent controlling portion 60 performing the luminescence controls.

Furthermore, the luminescent elements used are not be limited to LEDs or semiconductor lasers. It is needless to say that if they can be controlled or restricted in the wavelength and band, any other laser element or luminescent element may be used.

The effects of the present invention based on the above first and second embodiments described can be summarized as follows:

By controlling the luminescent output of each of the luminescent portions to make only a necessary wavelength band luminescent while the other luminescent wavelength bands are restricted, an optical component of an unnecessary wavelength harmful to a human body can be suppressed, thereby suppressing adverse effects on an object, an operator, or an observer.

Also, light of a wavelength required can be emitted when required such that the luminescent wavelength band of at least one luminescent portion is e.g. a visible optical band, in which excitation wavelength bands of the fluorescein or 5ALA that is a fluorescent angiogram agent are included while besides the visible optical band, e.g. excitation wavelength bands of the indocyanine green, fluorescein or 5ALA that is a fluorescent angiogram agent are included. Accordingly, the efficiency is good and the excitation light wavelength required for obtaining fluorescence from an object can be selectively irradiated.

Further, with using a semiconductor laser in the luminescent portion, an optical source with a higher output and a larger lifetime and easily restricted in wavelength can be obtained

Moreover, with using semiconductor devices such as LEDs or semiconductor lasers for the luminescent portion, a self diagnosis function such as detecting a luminescent state can be achieved.

What is claimed is:

1. An optical source device comprising:
a plurality of luminescent portions which each have a different luminescent wavelength band;
wavelength restricting portions which each restrict each luminescent wavelength band of the luminescent portions;
a mixing portion which mixes outputs of the wavelength restricting portions; and
a controlling portion which controls each luminescent output of the luminescent portions to emit light of only a necessary wavelength band.

2. An optical source device according to claim 1, wherein the luminescent portions each include an LED (Light Emitting Diode) and the wavelength restricting portions each comprise a BPF (Band Pass Filter).

3. An optical source device according to claim 2, wherein the luminescent portions each have a plurality of LEDs and detection circuits for detecting an abnormality of a corresponding LED, and when the detection circuits detect the abnormality of the corresponding LED, the controlling portion responsively changes the abnormal LED to a reserved LED.

4. An optical source device according to claim 1, wherein the luminescent portions are each composed of a laser driving portion and a semiconductor laser luminescent portion driven by the laser driving portion and the wavelength restricting portions are each composed of a thermo sensor which detects a temperature of the laser luminescent portion and a cooling device which is controlled by the laser driving portion depending on the temperature detected and controls the laser luminescent portion to a temperature corresponding to a wavelength required.

5. An optical source device according to claim 4, wherein the laser driving portion includes detection circuits which detect currents of luminescent elements in the laser luminescent portion to perform driving current controls.

6. An optical source device according to claim 5, wherein the laser driving portion has at least two detection circuits, and the laser luminescent portion has at least two luminescent elements each connected to the detection circuits, in which one serves as a reserve for the other.

7. An optical source device according to claim 1, wherein a luminescent wavelength band of at least one of the luminescent portions is a visible optical band.

8. An optical source device according to claim 7, wherein the visible optical band includes an excitation wavelength band of fluorescein or 5ALA that is an angiogram agent.

9. An optical source device according to claim 7, wherein the wavelength band outside the visible optical band includes an exciting wavelength band of an indocyanine green, fluorescein or 5ALA that is an angiogram agent.
